(19) United States
(12) Patent Application Publication
(10) Pub. No.: US 2010/0129261 A1
(43) Pub. Date: May 27, 2010

(54) Spectral sensor for surface-enhanced raman scattering

(75) Inventors: Bongsoo Kim, Daejeon (KR); Ilsun Yoon, Daejeon (KR); Taejoon Kang, Daejeon (KR)

Correspondence Address: CANTOR COLBURN, LLP, 20 Church Street, 22nd Floor, Hartford, CT, 06103, US

(73) Assignee: KOREA ADVANCED INSTITUTE OF SCIENCE AND TECHNOLOGY, Daejeon (KR)

(21) Appl. No.: 12/654,665

(22) Filed: Dec. 29, 2009

Related U.S. Application Data
(63) Continuation of application No. PCT/KR2007/005563, filed on Nov. 5, 2007.

(30) Foreign Application Priority Data
Jun. 29, 2007 (KR) 10-2007-0065063

(51) Int. Cl. G01N 21/47; G01J 3/44; G01N 21/84; G01N 21/75

(52) U.S. Cl. 422/82.05; 356/301; 977/762; 977/920; 977/959

(57) ABSTRACT

The spectral sensor for surface-enhanced Raman scattering (SERS) of the present invention is prepared with a single-crystal noble metal nanowire which has a high quality, a high purity and an excellent shape. Thus, the sensor can be used for in-situ detection. Further, since a sensor site for reacting with irradiated laser beam can have a controlled structure, shape and a controllable hot spot, reliability and reproducibility are excellent and sensitivity of the sensor can be improved. In addition, with the optimization of a mechanical structure of a single noble metal single-crystal nanowire and a polarization direction of laser beam, sensitivity, selectivity and signal intensity become high. Furthermore, the spectral sensor for surface-enhanced Raman scattering of the present invention can be advantageously used not only as a sensor for detecting chemicals but also as a biosensor and a sensor for diagnosis of disease.

### TECHNICAL FIELD

The present invention relates to a spectral sensor of SERS (Surface-Enhanced Raman Scattering) having a well-defined nanostructure and a use thereof for chemical and biological sensing with high reliability, high reproducibility, and ultra high sensitivity.

### BACKGROUND ART

SERS is a spectroscopic method which utilizes a phenomenon that when molecules are adsorbed on a nanostructure surface of metal such as gold and silver, etc. intensity of Raman scattering is dramatically increased to the level of 10⁶-10⁸ times compared with normal Raman signals. Together with a nanotechnology which is currently being developed fast, SERS sensor can be further developed for high sensitive detection of a single molecule. In addition, it is highly expected that SERS sensor can be used importantly as a medical sensor.

SERS sensor has a great advantage over an electrical nano sensor which gives a sensing signal by the resistance change of a sensor when molecules are adsorbed on the sensor. The reason is that, experimental data measured with a resistance sensor is a scalar value while for SERS sensor a whole spectrum of vector data can be obtained so that the amount of information which can be obtained from a single measurement is much bigger for the latter than the former.

Kneipp and Nie, et. al. have reported for the first time that single molecule SERS detection can be carried out by using aggregated metal nanoparticles. Since then, many studies of SERS enhancement with various nanostructures (nanoparticles, nanoshell, and nanowires) have been reported. In order to utilize SERS as a high sensitive detection method for a biosensor, Mirkin et. al. reported high sensitive DNA analysis by using nanoparticles that are coated with DNAs.

In addition to high sensitive DNA analysis, many studies are actively being carried out to use SERS sensors for early diagnosis of various diseases such as Alzheimer's disease and diabetes, etc.

Thus, it can be said that because SERS provides information of the conformation and vibrational states of the molecules that is obtainable by Raman spectroscopy, SERS is a high selective detection method that give more information on molecules than conventional detection methods such as laser fluorescence analysis, etc. SERS is a powerful analytical method with ultra-high sensitivity for chemical/biological/biochemical sensing.

In spite of such advantages, there are still many problems of SERS to be solved: \textcircled{1} SERS mechanism has not been completely understood, \textcircled{2} synthesis and control of well-defined nanostructures are difficult, and \textcircled{3} reliability and reproducibility of SERS signals depending on the wavelength and the polarization direction of the excitation light need to be improved. Such problems remain as a biggest issue of SERS applications to achieve a development and a commercialization of nano-bio SERS sensors.

In order to solve above problems, studies for optical properties and precise SERS enhancement controls of well defined nanostructures are now more required than ever before.

Moskovits, Halas, and van Duyne et. al. recently showed that SERS enhancement can be controlled and optimized by using a well-defined nanostructures. Moskovits and Yang et. al., respectively reported that SERS enhancement can be controlled by using metal nanowire bundles. In 2006, Moerner et. al. reported a SERS active nanostructure of a nanobowtie fabricated by using electron beam lithography.

Presently, a SERS sensor using nanoparticles is most widely studied. Base structure for SERS which has been suggested by Binger and Bauer, et. al. is an optical structure which is made of metal island film (MIF) on a flat metal surface. MIF consists of metal particles in two-dimensional random array and can be up to several nanometers in length and width, respectively. In this structure, the shape of metal particles can be diverse and the arrangement of metal particles has a random structure that is decided by chance. Thus, it is impossible for MIF to obtain a well-defined structure and reproducibility and reliability cannot be obtained from such SERS sensor. In addition, due to a diverse shape of metal particles, a uniform scattering intensity cannot be obtained.

Problems associated with a SERS sensor are described above in view of MIF structure as an example. However, such problems are general for a SERS sensor which uses metal nanoparticles. Specifically, obtainment of a well-defined structure remains as a difficult subject to achieve because it is impossible to control a shape of metal particles and parameters of metal surface. The size of the metal particles, which is less than 5 nm, remains as an intrinsic limitation.

Instead of metal particles, metal nanowires, especially Ag nanowires have been used in some studies to produce SERS sensor.

Using Langmuir-Blodgett method, Tao et. al. (Nano. Lett. 2003, 3, 1229) produced a monolayer consisting of a great amount of Ag nanowire on Si wafer and carried out a SERS measurement using it (see FIG. 1). Although the structure and the manufacturing method of the sensor suggested by Tao et. al. are based on the use of Ag nanowire and the long axis of Ag nanowire which consists of the monolayer has a somewhat oriented direction, there is still a limitation that reproducible SERS signals could not be obtained.

Jeong et. al. synthesized a flat array (rafts) of Ag nanowire using a template (J. Phys. Chem. B 2004, 108, 12724). By using Ag nanowire rafts arranged in one direction (see FIG. 2), the enhanced SERS signal was observed and it was shown that SERS signal varied with the difference between a longitudinal direction of the nanowire and a polarization direction of laser. Jeong et. al. experimentally measured the polarization dependent SERS enhancement based on an interaction between a polarization direction of laser and two nanowires. However, being a flat array structure, a great amount of Ag nanowire participates in SERS and Ag nanowire having high quality and excellent shape cannot be obtained due to a nature of said method for producing Ag nanowire as described above. In addition, SERS enhancement could not be finely controlled due to said interaction between the polarization direction of laser and two nanowires.

Aroca et. al. (Anal. Chem. 2005, 77, 378) reported a large-quantity synthesis of Ag nanowires for a SERS substrate at the liquid phase. However, as it is shown in FIG. 3, there are many particles present on the substrate in addition to the nanowires and it does not have a regular arrangement.

Schneider et. al. (J. Appl. Phys. 2005, 97, 024308) and Lee et. al. (J. Am. Chem. Soc. 2006, 128, 2200) respectively produced an Ag nanowire array using a template and carried out a SERS measurement while either maintaining the template or removing the template by etching. As a result, it was found that more SERS signals were obtained by removing the template.

Proke et. al. (Appl. Phys. Lett., 2007, 90, 093105) reported SERS enhancement of ZnO and Ga₂O₃ nanowires coated with Ag, respectively. SERS enhancements of the nanostructures are determined by the shapes of ZnO and Ga₂O₃ nanowires. Ga₂O₃ nanowires get entangled but ZnO nanowires do not. Further, it was found that when entangled Ga₂O₃ nanowires are used, stronger SERS signals can be taken.

The SERS enhancement studies reported by the above-described works by Jeong, Proke, Schneider, and Lee, et. al. and with a dimer of metal particles support the theoretical SERS studies of Brus and Käll on the SERS enhancement where SERS results from the very strong electric field (i.e., hot spot or interstitial field) that is formed between at least two nanoparticles that are in close contact with each other (1-5 nm), instead of between metal particles that are isolated. According to a theoretical calculation based on electromagnetic principle, SERS enhancement of ˜10¹² times is expected at the hot spot.

Still, similar to a spectral sensor using metal nanoparticles, a spectral sensor for SERS using nanowires is problematic in terms of controlling shape and quality of the nanowires. In addition, the physical structure of the produced nanowires has not been well-defined and the occurrence of hot spot, which is essential for SERS enhancement, could not be precisely controlled. Thus, reliability and reproducibility are not certain and the SERS signal could not be controllably carried out, making it difficult to develop a sensor using it. Especially for a cluster of nanoparticles, an occurrence, a position and intensity of hot spot may vary depending on the degree of clustering and it is known as a huge problem for maintaining reproducibility and controlling SERS signals.

As explained in the above, leading research groups of van Duyne and Halas, et. al. developed their own nano systems such as nanopattern and nanoshell and improved the reproducibility and the control of SERS enhancement by taking advantage of surface plasmon property of the systems. Currently, they are also trying to develop biosensors using the nanostructures. However, a SERS spectral sensor of nanowires, which is easy to be produced with high quality, high purity, and excellent shape and where individual position and structure of nanowires on a substrate can be controlled and the hot spot can be precisely controlled, has not been developed yet.

Inventors of the present invention recently succeeded in synthesis of the single-crystal Ag nanowire and single-crystal Au nanowire by using a vapor phase method. Single-crystal Ag nanowire has the highest conductivity among metals. Thus, it can be used for developing a nanodevice and an electrical nanosensor using it.

Noble metal nanowires produced without any catalysts by using a vapor phase method have a clean single-crystal surface which can be used for assembled structures of biomolecules on the surface of the nanowire. The nanowires have an excellent shape and they are individually separated to a size that can be precisely controlled even with an optical microscope. Nanowires having such advantages will be very useful for a study to understand a basic mechanism of SERS enhancement such as a change in SERS enhancement due to different wavelengths of light and an interaction between polarization direction and surface plasmon of the nanomaterials.

Inventors of the present invention conducted a research to control SERS enhancements by using nanowires that are produced by a vapor phase method and have a well-defined surface and crystal state, and to enhance SERS signals from chemicals, proteins, and biomolecules such as DNA and to improve reproducibility therefor. As a result, the present invention was completed. If a well-defined and efficient SERS system is manufactured by using the single-crystal nanowires produced by said vapor phase method, a great improvement can be made in development of a biosensor and a sensor for diagnosis of disease.

### DISCLOSURE OF INVENTION

### [Technical Subject]

For solving the above-described problems, the object of the present invention is to provide a SERS spectral sensor which is easily produced, consists of nanowires with high quality, high purity and excellent shape and where the structure and the individual position of the nanowires on a substrate is controlled and the occurrence of hot spot is precisely controlled. Another object of the present invention is to provide a condition for operating a SERS spectral sensor to improve its sensitivity. Still another object of the present invention is to provide a use of the spectral sensor of the present invention for chemical and biological sensing with ultra high sensitivity, high reliability, high reproducibility and high structure specificity.

### [Technical Solution]

The spectral sensor for SERS (Surface-Enhanced Raman Scattering) of the present invention is a spectral sensor for determining the presence and the amount of biological or chemical materials in an analyte applied to the sensor, and used in conjunction with laser beam and Raman spectrometer. The spectral sensor of the present invention consists of (i) a substrate, (ii) a noble metal thin film located on top of the said substrate and (iii) single-crystal noble metal nanowires located on top of the said noble metal thin film, wherein a contact point is formed between the said noble metal thin film and the said noble metal nanowires and an enhancement of SERS is achieved by hot spots that are formed on said contact point (hereinafter, it is referred to as ‘spectral sensor Structure A’).

In addition, the spectral sensor of the present invention is a spectral sensor for determining the presence and the amount of biological or chemical materials in an analyte applied to the sensor, and used in conjunction with laser beam and Raman spectrometer. The spectral sensor of the present invention consists of (i) a substrate, and (ii) single-crystal noble metal nanowires located on top of the said substrate, wherein a contact point is formed by a physical contact of the said two noble metal nanowires and an enhancement of SERS is achieved by hot spots that are formed on the said contact point (hereinafter, it is referred to as ‘spectral sensor Structure B’).

In the above-described spectral sensor of the present invention, the structure (or position) of the noble metal nanowires consisting of the SERS sensor is physically adjusted and based on a physical contact (contact point) between two nanowires or a physical contact (contact point) between a single nanowire and the noble metal film that is formed on top of the substrate a controlled hot spot is created.

Substrate which can be used for said spectral sensor Structure A or spectral sensor Structure B can be anyone that is inert to SERS and non-reactive to the noble metals. For spectral sensor Structure A, it is preferably silicon single-crystal substrate, sapphire single-crystal substrate, glass substrate, gypsum substrate or mica substrate, etc. For spectral sensor Structure B, it is preferably silicon single-crystal substrate, sapphire single-crystal substrate, glass substrate, gypsum substrate or mica substrate, etc.

Nobel metal nanowires that are applied to the spectral sensor of the present invention are produced by heat-treating under the stream of inert gas a precursor comprising oxides of noble metal, noble metals or noble metal halides that is placed at front end of a reacting furnace and a semiconducting or nonconducting single-crystal substrate that is placed at rear end of the furnace. As a result, noble metal single-crystal nanowire is formed on the said single-crystal substrate.

The said method for producing noble metal single-crystal nanowire does not use a catalyst, instead it simply uses a precursor including oxides of noble metal, noble metals or noble metal halides to form a noble metal nanowire on the single-crystal substrate. Since noble metal single-crystal nanowires are produced along the drift of the materials in vapor phase without using catalyst, the operation process is simple and reproducible. In addition, it is favorable in that highly pure nanowires having no impurities can be produced.

In addition, according to the said method, temperatures at the front and the rear ends of the furnace are controlled, respectively, and by adjusting the flow rate of the inert carrier gas and a tubular pressure needed during the said heat treatment, driving forces for the metal nucleus formation and its growth, nucleation rate for the nucleus formation and its growth rate on the single-crystal substrate are all controlled. Thus, it is possible to control and to reproduce the size of the noble metal single-crystal nanowire and its density on the substrate, etc. As a result, a high quality noble metal single-crystal nanowire which is free of any defect and has high crystallinity can be obtained.

In this connection, the essential feature of the method of the present invention is the use of a precursor including oxides of noble metal, noble metals or noble metal halides to form a noble metal nanowire using a vapor phase transfer method while no catalyst is used. The most important condition to produce metal nanowires having high purity, high quality and excellent shape is temperatures at the front and the rear ends of the reacting furnace, flow rate of the said inert carrier gas and pressure during the said heat treatment.

The said conditions including heat treatment temperature, flow rate of inert carrier gas and pressure during the heat treatment can be independently varied. However, only when the said three conditions are varied depending on the state of others, noble metal single-crystal nanowires having preferred quality and shape can be obtained.

Preferably, the temperature at the front end of the furnace is maintained to be higher than that at the rear end. Specifically, difference in temperature between the front end and the rear end is within the range of 0 and 700° C. (i.e., the temperature of the front end is about from 0 to 700° C. higher than that of the rear end).

Regarding the flow rate of the inert carrier gas, preferably 100 to 600 sccm gas is introduced from the front end to the rear end. Preferably, the flow rate is between 400 and 600 sccm, and more preferably the flow rate is between 450 and 550 sccm.

The pressure for the said heat treatment is preferably lower than the atmospheric pressure. More preferably the pressure is between 2 and 50 torr, and the most preferably the pressure is between 2 and 20 torr. However, depending on characteristic of a precursor, the atmospheric pressure can be also used.

As a precursor for producing noble metal nanowires of the present invention, oxides of noble metal, noble metals, or noble metal halides can be used. The said oxide of the noble metal is selected from silver oxide, gold oxide or palladium oxide. The said noble metal is selected from silver, gold or palladium. The said noble metal halide is preferably selected from noble metal fluoride, noble metal chloride, noble metal bromide, or noble metal iodide. More preferably, it is selected from noble metal chloride, noble metal bromide or noble metal iodide. Most preferably, it is noble metal chloride. The said noble metal halide is preferably selected from gold halide, silver halide or palladium halide. In addition, the said gold halide is preferably selected from gold fluoride, gold chloride, gold bromide or gold iodide. The said silver halide is preferably selected from silver fluoride, silver chloride, silver bromide or silver iodide. The said palladium halide is preferably selected from palladium fluoride, palladium chloride, palladium bromide or palladium iodide. Furthermore, the said noble metal halide includes a hydrate of noble metal halide.

For the said oxides of noble metal, gold oxide, silver oxide, palladium oxide, platinum oxide, iridium oxide, osmium oxide, rhodium oxide or ruthenium oxide can be used. By using the said oxides of noble metal, single-crystal nanowires made of gold, silver, palladium, platinum, iridium, osmium, rhodium, or ruthenium can be produced.

The said oxides of noble metal including gold oxide, silver oxide, palladium oxide, platinum oxide, iridium oxide, osmium oxide, rhodium oxide or ruthenium oxide can be an oxide having a stoichemical ratio that is thermodynamically stable at the room temperature and the atmospheric pressure. In addition, it can be an oxide of noble metal which does not have the said stable stoichemical ratio due to the presence of a point defect that is caused by noble metal or oxygen.

The above-described precursor is preferably an oxide of noble metal or a noble metal. More preferably, it is an oxide of noble metal.

Especially for Ag and Au nanowires, silver, silver oxide or silver halide is used as a precursor to produce Ag single-crystal nanowire. In this case, the temperature of the front end of a reacting furnace is preferably about from 250 to 650° C. higher than of the rear end. Preferably, the said precursor (oxide of noble metal) is maintained at the temperature of between 850 and 1050° C. and a single-crystal substrate is maintained at the temperature of between 400 and 600° C. For Au nanowires, gold, gold oxide or gold halide is used as a precursor to produce Au single-crystal nanowire. In this case, the temperature of the front end of a reacting furnace is preferably about from 0 to 300° C. higher than of the rear end. Preferably, the said precursor is maintained at the temperature of between 1000 and 1200° C. and the said single-crystal substrate is maintained at the temperature of between 900 and 1000° C.

Among the noble metal nanowires that are added to the SERS spectral sensor of the present invention, Ag nanowire and Au nanowire were produced in the following Example 1 and Example 2 according to the above-described preparation method.

### BRIEF DESCRIPTION OF DRAWINGS

The patent or application file contains at least one drawing executed in color. Copies of this patent or patent application publication with color drawings will be provided by the Office upon request and payment of the necessary fee.

FIG. 1 is a structure of the conventional spectral sensor using Ag nanowires.

FIG. 2 is a structure of another conventional spectral sensor using Ag nanowires.

FIG. 3 is a structure of yet another conventional spectral sensor using Ag nanowires.

FIG. 4 is a scanning electron microscope (SEM) photo of Ag nanowires which are prepared according to Example 1 of the present invention.

FIG. 5 is a transmission electron microscope (TEM) photo of a Ag nanowire which is prepared according to Example 1 of the present invention.

FIG. 6 is an electron diffraction pattern of a Ag nanowire along a zone axis, wherein the said nanowire is prepared according to Example 1 of the present invention.

FIG. 7 is a high resolution transmission electron microscope (HRTEM) photo of Ag nanowire which is prepared according to Example 1 of the present invention.

FIG. 8 is a result from energy dispersive spectroscopy (EDS) of a Ag nanowire which is prepared according to Example 1 of the present invention.

FIG. 9 is a result from X-ray diffraction (XRD) of Ag nanowires which are prepared according to Example 1 of the present invention.

FIG. 10 is a SEM photo of Au nanowires which are prepared according to Example 2 of the present invention.

FIG. 11 is a result from XRD of Au nanowires which are prepared according to Example 2 of the present invention.

FIG. 12 is a TEM result of Au nanowire which is prepared according to Example 2 of the present invention. FIG. 12 (a) is a result from selected area diffraction of the Au nanowire of FIG. 12(b) and FIG. 12(b) is a dark-field image of a Au nanowire.

FIG. 13 is a result from EDS of Au nanowire which is prepared according to Example 2 of the present invention.

FIG. 14 is a diagram showing the structure of the spectral sensor according to the present invention. FIG. 14(a) shows Structure A of the spectral sensor according to the present invention and FIG. 14(b) shows Structure B of the spectral sensor according to the present invention.

FIG. 15 is an optical microscope photo of spectral sensors which are prepared according to Examples of the present invention. FIG. 15(a) is for the spectral sensor prepared in Example 3, FIG. 15(b) is for the spectral sensor prepared in Example 4, FIG. 15(c) is for the spectral sensor prepared in Example 5, FIG. 15(d) is for the spectral sensor prepared in Example 6,and FIG. 15(e) is for the spectral sensor prepared in Example 7, respectively.

FIG. 16 is a set of apparatuses that are used for measuring Raman spectrum using the spectral sensor prepared according to the present invention.

FIG. 17 is an optical microscope photo and a result from a Raman spectrum measurement obtained by using a spectral sensor which is prepared according to Example 3 of the present invention. FIG. 17(a) is an optical microscope photo of a Ag spectral sensor, FIG. 17(b) shows a change in Raman spectrum of BCB molecule in accordance with a change in laser polarization, FIG. 17(c) shows a change in strength of local electric field in accordance with a change in laser polarization, wherein said change in strength of local electric field has been calculated using a finite difference time domain (FDTD) method, and FIG. 17(d) shows a change in intensity of Raman spectrum enhancement in accordance with a change in laser polarization, wherein the data is plotted for different θ values.

FIG. 18 is an optical microscope photo and a result from a Raman spectrum measurement obtained by using a spectral sensor which is prepared according to Example 4 of the present invention. Green spots shown in FIGS. 18(a), 18(b) and 18(c) correspond to the laser beam irradiated to obtain Raman spectrum at a certain position. FIGS. 18(d), 18(e) and 18(f) are the results of Raman spectrum for BCB molecule taken at various positions.

FIG. 19 is an optical microscope photo and a result from a Raman spectrum measurement obtained by using a spectral sensor which is prepared according to Example 5 of the present invention. FIG. 19(a) is an AFM image of the spectral sensor, FIG. 19(b) shows a result of Raman spectrum for BCB molecule, FIG. 19(c) shows a decrease and increase in Raman spectrum depending on a change in direction of light polarization.

FIG. 20 is a diagram showing alkyl thiol functional groups assembled on the single crystalline metal surface.

FIG. 21 is a Raman spectrum of self-assembled pMA obtained by using a spectral sensor which is prepared according to Example 6 of the present invention.

FIG. 22 is a Raman spectrum of pMA obtained by using a spectral sensor which is prepared according to Example 6 of the present invention, wherein the data is given for various polarized laser beams.

FIG. 23 is a distribution of local electric field in a spectral sensor in accordance with a change in laser polarization, wherein the sensor has self-assembled pMA and is prepared according to Example 6 of the present invention and said distribution is calculated using FDTD method.

FIG. 24 is a Raman spectrum of adenine using a spectral sensor which is prepared according to Example 7 of the present invention. Specifically, FIG. 24(a) is Raman spectrum of adenine molecule which is measured under the condition that laser focus is present on Au nanowire and polarization of laser beam is at a right angle with a long axis of the nanowire. FIG. 24(b) is the result obtained under the condition that polarization of the laser beam is parallel to a long axis of the nanowire. FIG. 24(c) is the result obtained under the condition that laser focus is present over gold thin film. FIGS. 24(d) and (e) are an optical photo image taken under the condition that laser focus is present on Au nanowire or gold thin film, respectively.

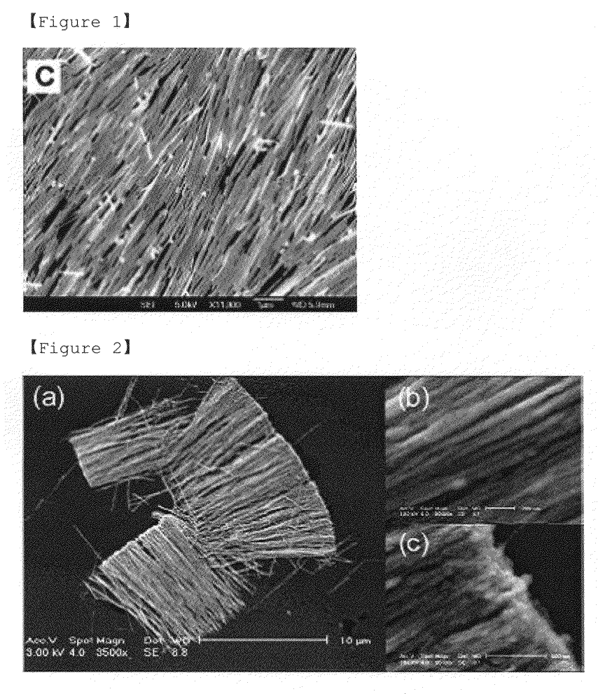

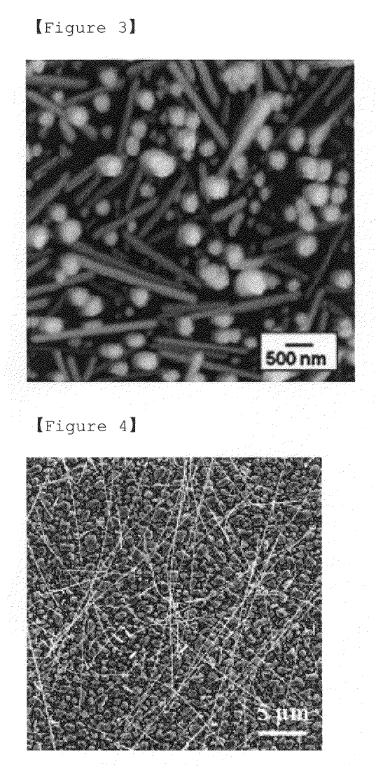

### BEST MODE

### EXAMPLE 1

### Preparation of Ag Nanowires that Compose of the Spectral Sensors of the Present Invention

Ag single-crystal nanowire was produced in a reacting furnace using a vapor phase transfer method. The reacting furnace has a separate front end and a rear end, and is independently equipped with a heating element and a temperature controlling device. The tube inside in the reacting furnace is based on a quartz material that is 60 cm long and has a diameter of 1 inch.

At the center of the front end of the furnace, a boat-shaped vessel which is made of highly pure alumina and contains 0.5 g of Ag₂O (Sigma-Aldrich, 226831) as a precursor was placed. At the center of the rear end of the furnace, a silicon plate was placed. Argon gas was injected to the front end of the furnace and escaped through the rear end of the reacting furnace. At the rear end a vacuum pump was also attached. By using the vacuum pump, the pressure inside said quartz tube was kept at 15 torr, and using a MFC (Mass Flow Controller), a stream of 500 sccm Ar gas was flowed.

For said silicon substrate, a silicon wafer having (100) crystal plane on which a oxide layer has been formed was used.

Ag single-crystal nanowire was produced by heat treatment for 30 min while maintaining the temperatures of the front end (i.e., the alumina boat containing the precursor) and the rear end of the reacting furnace (i.e., the silicon wafer) at 950° C. and 500° C., respectively.

### EXAMPLE 2

### Preparation of Au Nanowires that Compose of the Spectral Sensors of the Present Invention

Au single-crystal nanowire was synthesized in a reacting furnace using a vapor phase transfer method. Except precursor, temperature for heat treatment and single-crystal substrate material, Au nanowire was synthesized using the same condition and the devices as described in Example 1.

For a precursor, 0.05 g Au₂O₃ (Sigma-Aldrich, 334057) was used. A sapphire substrate of (0001) plane was used as a single-crystal substrate.

Au single-crystal nanowire was produced by heat treatment for 30 min while maintaining the temperatures of the front end (i.e., the alumina boat containing the precursor) and the rear end of the reacting furnace (i.e., the sapphire substrare) at 1100° C. and 900° C., respectively.

For the noble metal single-crystal nanowires that compose of the SERS spectral sensors as prepared in the said Example 1 and Example 2, quality, shape and purity, and etc. of the nanowire were determined.

FIGS. 4 to 9 show a result obtained from the measurements using Ag nanowire which was prepared in Example 1.

FIG. 4 is a SEM photo of Ag nanowire which has been prepared on the silicon single-crystal substrate. As it is shown in FIG. 4, a great amount of nanowires was produced in a uniform shape having the length of tens of micrometers, separated from the silicon single-crystal substrate. A straight shape extended along the long axis of the nanowires was observed. In addition, Ag nanowires, which can be individually separated from each other, were produced without aggregation. For the Ag single-crystal nanowire obtained above, the diameter of its short axis was in the range of between 80 and 150 nm. The length of the long axis was at least 10 μm.

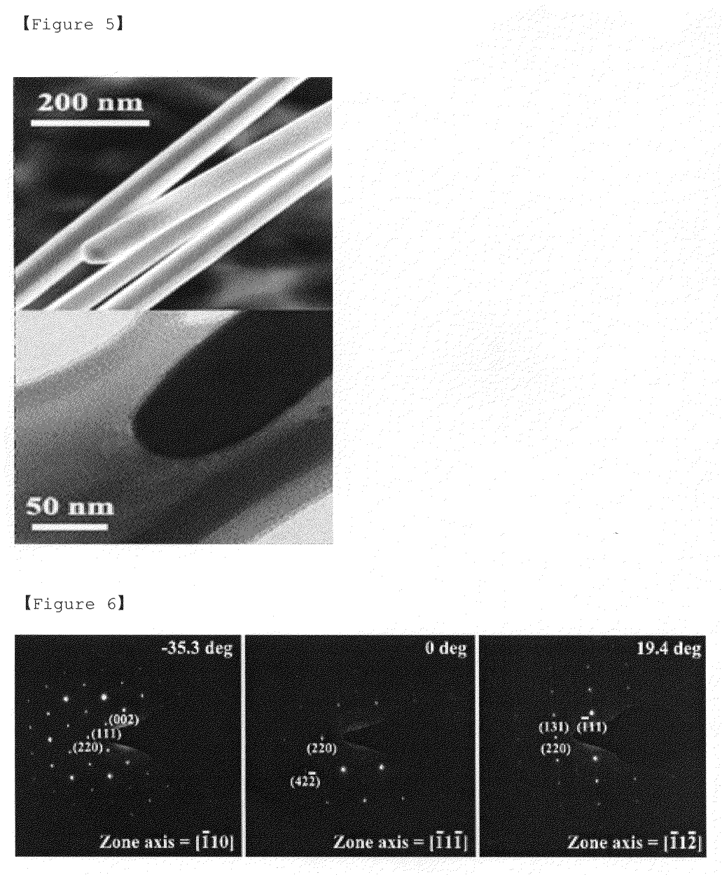

FIG. 5 is a TEM photo of Ag nanowire. Close determination of the shape of the Ag nanowire that was prepared in Example 5 suggests that the Ag nanowire having a smooth surface has been formed. In addition, its section that is perpendicular to the growth direction of said Ag single-crystal nanowire has a smooth curvy shape wherein a tangential tilt on outer periphery of said section is continuously changed. For minimization of surface energy, the said section has a circular shape. Furthermore, the section at the growth end of the Ag single-crystal nanowire has an oval shape having no sharp angle.

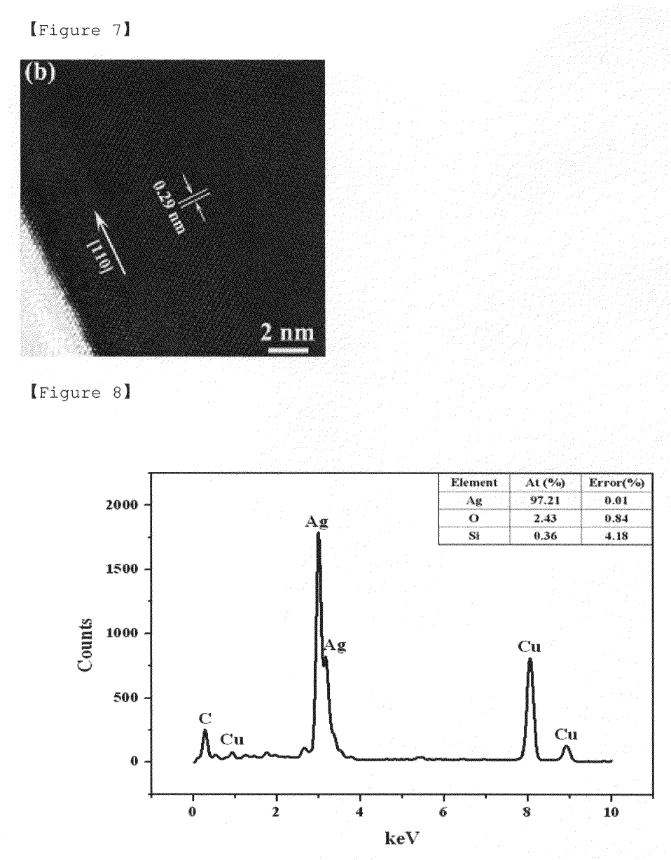

FIG. 6 is a SAED (selected area electron diffraction) pattern of a single Ag nanowire, wherein the said pattern is measured with respect to three zone axes. Based on the diffraction pattern shown in FIG. 6, it is found that one Ag nanowire of the present invention is a single crystal. Further, according to the distance between the diffraction points and the zone axis points (transmission points) and the results of the electronic diffraction pattern along the zone axis, it was found that the produced Ag nanowire has a FCC (face centered cubic) structure. In addition, it was also confirmed that the nanowire has the same unit cell size as that of bulk Ag.

FIG. 7 is a HRTEM (high resolution transmission electron microscope) image of the Ag nanowire. As it can be seen from FIG. 7, the surface of the long axis of the smoothly curved Ag nanowire has an atomically rough structure. Growth direction of the Ag nanowire was in <110> direction. In addition, the gap present between (110) planes were 0.29 nm wide, which is the same as that of bulk Ag. Further, From the growth direction analysis of many other Ag nanowires using an electronic diffraction method based on TEM, it was confirmed that there are other Ag nanowires having growth direction of <100> instead of <110>.

FIG. 8 shows the result of the constitution analysis of Ag nanowire by using EDS (energy dispersive spectroscopy) which is installed at TEM apparatus. As it has been shown in FIG. 8, except some other substances that are inevitably measured due to a characteristic of the measurement apparatuses such as grid, etc., it is clear that the nanowire produced according to the present invention consists of Ag only.

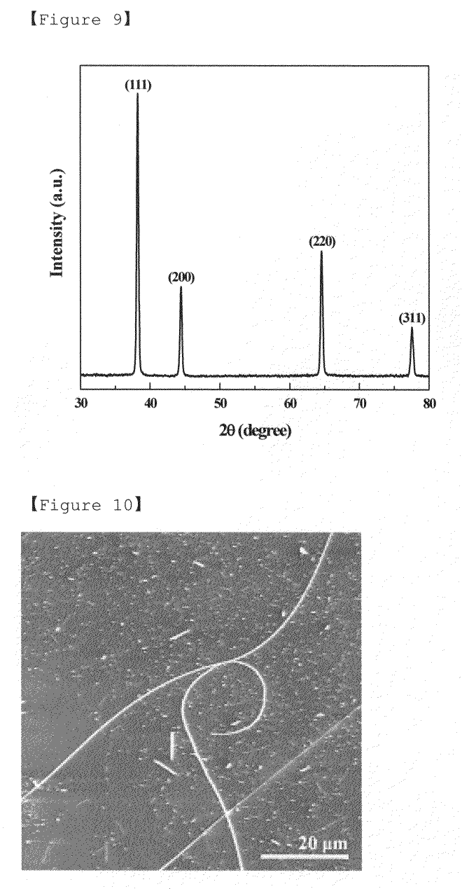

FIG. 9 shows the result of XRD (X-Ray diffraction) taken for Ag nanowire of the present invention. The diffraction data shown in FIG. 9 is in complete match with the diffraction data of bulk Ag without any peak shift. Thus, it is found that the Ag nanowire prepared by the present invention has a FCC (face centered cubic) structure.

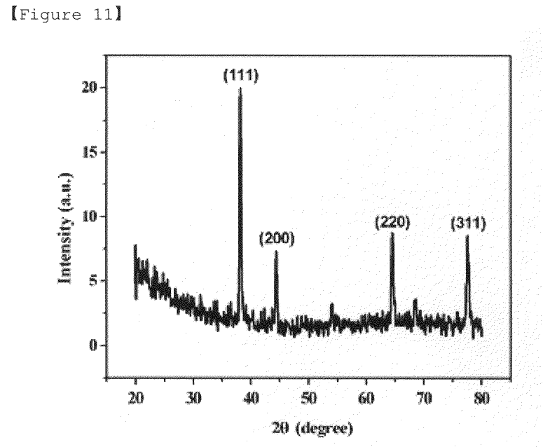

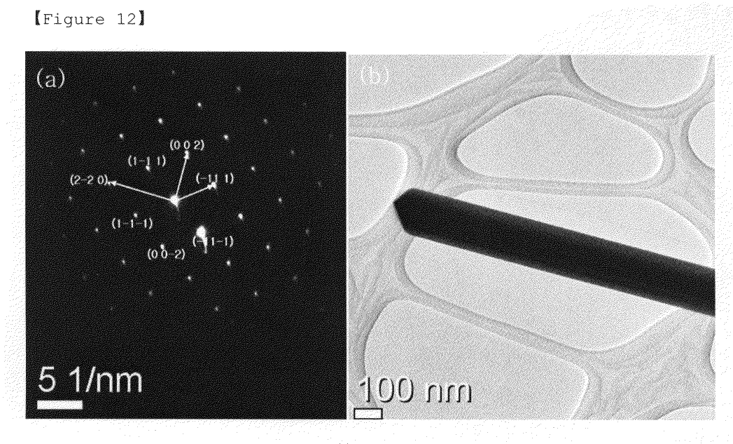

FIGS. 10 to 13 are the results obtained from the measurement of Au nanowire which has been prepared in the above-described Example 2. FIG. 10 is a SEM photo of Au nanowire which has been prepared on a sapphire single-crystal substrate. Similar to the result obtained from the above-described Ag nanowire, a great amount of nanowires was produced in a uniform shape having the length of tens of micrometers, separated from the sapphire single-crystal substrate. A straight shape extended along the long axis of the nanowires was observed. In addition, Au nanowires, which can be individually separated from each other, were produced without aggregation. For the Au single-crystal nanowire obtained above, the diameter of its short axis was in the range of between 50 and 150 nm. The length of the long axis was at least 5 μm.

FIG. 11 shows the result of XRD (X-Ray diffraction) taken for Au nanowire of the present invention. The diffraction data shown in FIG. 11 is in complete match with the diffraction data of bulk Au without any peak shift. Thus, it is found that the Au nanowire prepared according to the present invention has a FCC structure.

Close determination of the shape and the structure of the Au using TEM suggest that the Au nanowire has a smooth surface, as it is shown in FIGS. 12(a) and 12(b). Meanwhile, unlike the Ag nanowire described above, the end region at the growth direction of the said Au single-crystal nanowire has a faceted shape. SAED pattern given in FIG. 12(a) indicates that the structure of the Au nanowire synthesized above is single crystal. The growth direction (long axis) of the Au single-crystal nanowire is in <110> direction. Further, after analyzing the growth direction of many other Au nanowires using an electronic diffraction method based on TEM, it was confirmed that there are other Au nanowires having growth direction of <100> instead of <110>. In addition, each plane which constitutes the faceted surface of said nanowires having a faceted shape is a plane with low index like {111} {110} and {100}.

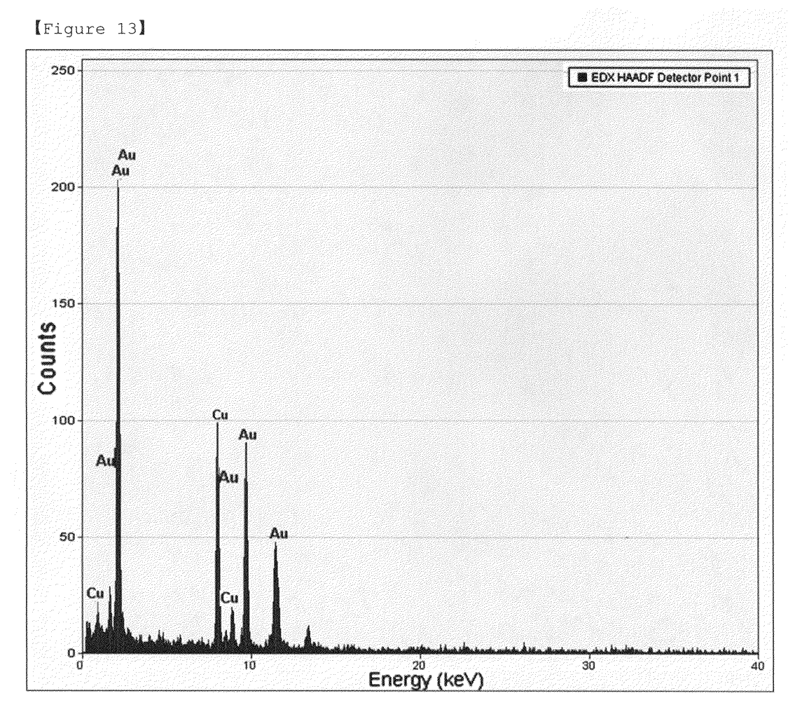

FIG. 13 shows the result of analyzing the constitution of Au nanowire by using EDS (energy dispersive spectroscopy) which is installed at TEM apparatus. As it has been shown in FIG. 13, except some other substances that are inevitably measured due to a characteristic of the measurement apparatuses such as grid, etc., it is clear that the nanowire produced according to the present invention consists of Au only.

Noble metal nanowire which is prepared by the method described above and composes of the SERS spectral sensor of the present invention has a uniform size regardless of base materials, is a single crystal with high quality, and a highly pure nanowire free of any impurities. In addition, a great amount of the nanowires can be formed on a substrate and each nanowire can be individually separated without entanglement. Especially, the Ag or Au nanowires that are applied to the SERS sensor of the present invention have high qualities, high purities and favorable shapes.

Noble metal nanowires obtained by the method described above have a short axis of which diameter is within the range of between 50 and 200 nm and a long axis of which length is at least 1 μm, and they are individually separated. Noble metal nanowires having the said dimension can be observed by an optical microscope and with the aid of general apparatuses their individual position on a substrate or relative position to each other can be adjusted. The said dimension of the nanowire is within the range that a specific structure consisting of at least one nanowire can be optionally formed.

Therefore, by using noble metal nanowires which have no entanglement, are individually separated to single-crystal substrates, and have a diameter of its short axis within the range of between 50 and 200 nm and the length of the long axis at least 1 μm, the position of the said noble metal nanowire on the said substrate can be decided by physically and individually controlling a single noble metal nanowire. In addition, the relative position between the noble metal nanowires can be also physically controlled. Especially regarding spectral sensor Structure B, various structures can be defined including a structure wherein the long axes of two noble metal nanowires are crossed over, a structure wherein the long axes of two noble metal nanowires are crossed at a right angle to each other, and a structure wherein two noble metal nanowires are in contact with each other in a direction of their long axes, etc.

As it is explained above, the direction and the position of the noble metal nanowire singularly present in spectral sensor Structure A can be physically and individually controlled. Regarding spectral sensor Structure B, two noble metal nanowires can be individually controlled so that they are made to be in contact with each other. For spectral sensor Structure B, the position and the direction of two noble metal nanowires can be also physically and individually controlled. In addition, having the said single noble metal nanowire of spectral sensor Structure A or two noble metal nanowires of spectral sensor Structure B that are physically contacting each other as one unit, many units can be present and the direction and the position of an individual unit can be also controlled.

As a result, the noble metal nanowire of the spectral sensor of the present invention becomes to have a well-defined structure as well as a well-controlled hot spot (for spectral sensor Structure A, a contact point between a noble metal thin film and a single noble metal nanowire serves as a hot spot and for spectral sensor Structure B, a contact region of noble metal nanowires that are in physical contact with each other serves as a hot spot).

Difference between spectral sensor Structure A and spectral sensor Structure B is determined by the type of the contact points (or contact lines) which create a local electrical field serving as a hot spot. As it is shown in FIG. 14, the said spectral sensor Structure A utilizes a contact point between a noble metal thin film and a single noble metal nanowire while the said spectral sensor Structure B utilizes a contact point between noble metal nanowires. As a result, they have structures which can be used for reliable and reproducible SERS enhancement.

Therefore, the said spectral sensor Structure B is not limited to the structure wherein two nanowires are in a simple physical contact with each other but also includes a spectral sensor structure wherein many nanowires are individually and physically controlled to have controlled contact points.

In addition, regarding spectral sensor Structure A of the present invention, the structure of nanowire on a noble metal thin film can be a cluster in which many noble metal nanowires are individually controlled and determined. For spectral sensor Structure A of the present invention, the contact points along a single nanowire on a noble metal thin film can form a line. Also, by adjusting the roughness of the noble metal thin film, number of said contact points can be controlled. Roughness of the noble metal thin film can be adjusted by a physical, chemical or thermal method, or a combination thereof. As a physical method, a fine particle having a certain size can be used for forming a physical scratch evenly on said noble metal thin layer, or considering that the noble metal is highly ductile but weak in strength a highly solid material having fine pattern formed on its surface can be brought in contact with said noble metal thin film and then pressurized to modify the surface roughness of the thin film. As a chemical method, an etching can be carried out by using a solution which can selectively etch grain boundary of the noble metal thin film which is made of polycrystalline material to modify the surface roughness of the thin film. As a thermal method, a mean particle size of polycrystalline material which constitutes the noble metal thin layer can be adjusted or a thermal grooving can be formed in grain boundary to modify the surface roughness of the thin film. In addition, base on a heat-treatment with an addition of chemical or physical elements, the surface roughness can be modified with recrystallization of polycrystalline material which constitutes the noble metal thin film it is known that, especially based on recrystallization of the surface of the noble metal using a chemical surface treatment using piranha solution or aqua regia, a mean particle size can be reduced and more even surface can be obtained.

The noble metal wires for the said spectral sensor Structure A or spectral sensor Structure B can be any of noble metal nanowires from which SERS enhancement is observed. Preferably, Ag nanowire or Au nanowire are used. In this case, since the noble metal thin film is provided in order to form a contact point with noble metal nanowire in the said spectral sensor Structure A, the thickness of the film is not specifically limited. Therefore, it also can be a thick film as well as a thin film. The noble metal thin film can be any one which can form a local electric field at a contact point with the noble metal nanowire that is present on top of the film, consequently forming a hot spot. Preferably, Ag film or Au film is used. More preferably, it is a thick or thin film made of a material which is the same as the noble metal nanowire that is present on top of the film (e.g., Ag nanowire-Ag thin film or Au nanowire-Au thin film).

Noble metal nanowire applied to the spectral sensor of the present invention does not involve a linking compound such as dithiol to link the nanowire to a substrate or to a noble metal thin film. Instead, the present invention is characterized in that thanks to its great mass and van der Waals bonding force the nanowire becomes strongly fixed to the substrate or to the noble metal thin film.

Spectral sensors having the above-described physical and structural properties were prepared in the following Examples 3 to 7. Following examples are provided as an example to fully deliver the spirit of the present invention to a skilled person in the art.

Thus, the present invention is not limited to the following examples and it can be carried out according to other possible embodiments.

### EXAMPLE 3

### Structure of Single Ag Nanowire Spectral Sensor

To top of Si single-crystal substrate (1 cm×1 cm) a solution of Ag nanowire which has been prepared in above Example 1 and diluted with ethanol (ethanol 2 ml, Ag nanowire 0.001 g) was added dropwise, in order to place Ag nanowire on top of the Si substrate.

### EXAMPLE 4

### Structure of Spectral Sensor Structure B having Ag Nanowire (Nanowire Structure having Nanowires Crossed at a Right Angle)

A highly concentrated nanowire solution which has been prepared by dispersing Ag nanowire of Example 1 in ethanol (ethanol 2 ml, Ag nanowire 0.001 g) was dispersed onto a glass substrate (2.5 cm×2.5 cm) to observe a nanowire structure having nanowires that are crossed at a right angle.

### EXAMPLE 5

### Structure of Spectral Sensor Structure B having Ag Nanowire (Nanowire Structure having Parallel Nanowires)

A highly concentrated nanowire solution which has been prepared by dispersing Ag nanowire of Example 1 in ethanol (ethanol 2 ml, Ag nanowire 0.001 g) was dispersed onto a glass substrate (2.5 cm×2.5 cm) to observe a nanowire structure having parallel nanowires.

### EXAMPLE 6

### Structure of Spectral Sensor Structure A having Ag Nanowire

On top of a Si single-crystal substrate having (100) surface Ag thin film was formed using E-beam evaporation apparatus (Korea vacuum, KVE T-0500200) under the condition of UHV (ultra high vacuum) with deposit speed of 0.2 nm/s (thickness of the film; 300 nm).

Ag nanowire solution which has been prepared by diluting Ag nanowire of Example 1 in ethanol (ethanol 2 ml, Ag nanowire 0.001 g) was sprinkled on top of said substrate (1 cm×1 cm) having a Ag thin film, in order to place Ag nanowire on top of Ag thin film.

### EXAMPLE 7

### Structure of Spectral Sensor Structure A having Au Nanowire

On top of a Si single-crystal substrate having (111) or (100) surface Au thin film was formed using E-beam evaporation apparatus (Korea vacuum, KVE T-0500200) under the condition of UHV (ultra high vacuum) with deposit speed of 0.2 nm/s (thickness of the film; 300 nm).

Au nanowire solution which is prepared by diluting Au nanowire of Example 2 in ethanol (ethanol 2 ml, Au nanowire 0.001 g) was sprinkled on top of said substrate (1 cm×1 cm) having a Au thin film, in order to place Au nanowire on top of Au thin film.

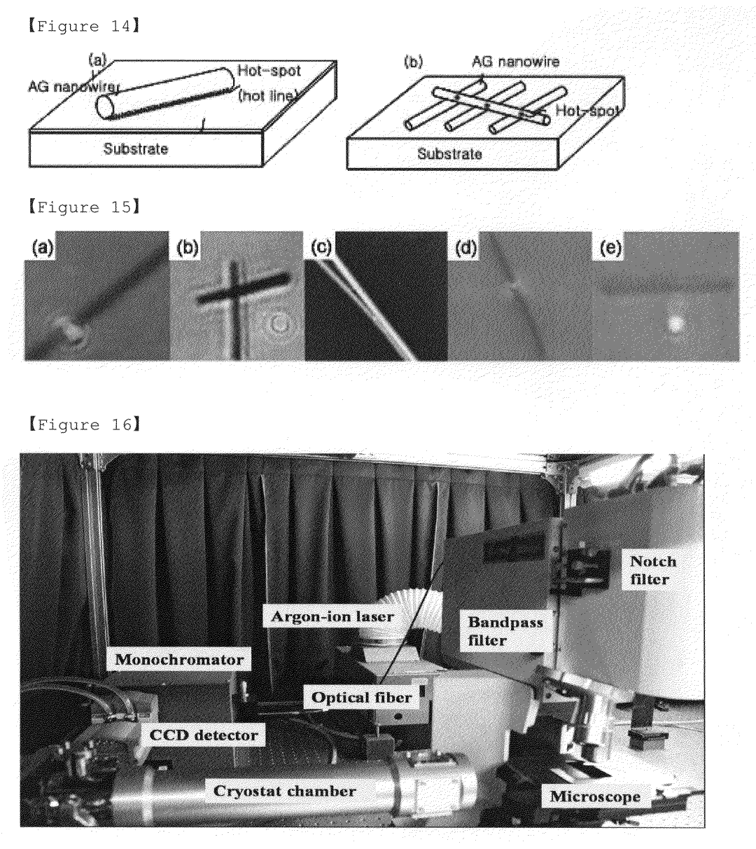

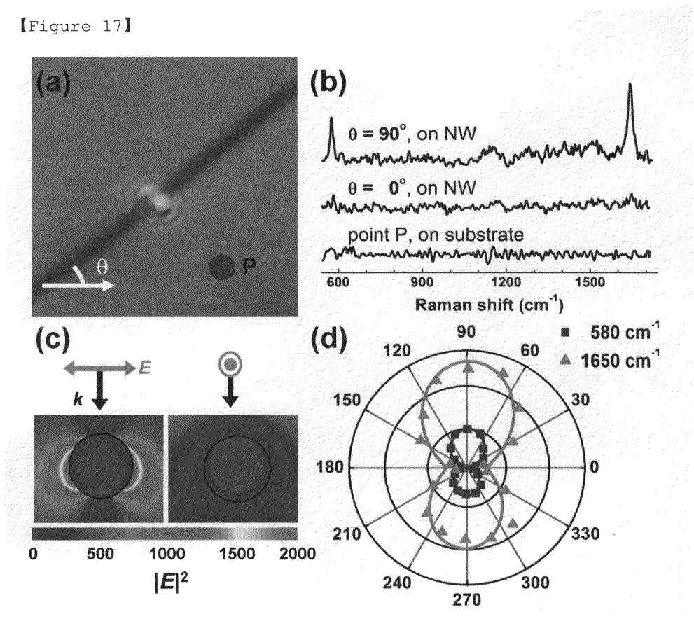

FIG. 15 is an optical microscope photo of spectral sensors which are prepared according to Examples of the present invention. FIG. 15(a) is for the spectral sensor prepared in Example 3 (hereinafter, referred to as single Ag spectral sensor), FIG. 15(b) is for the spectral sensor prepared in Example 4 (hereinafter, referred to as Ag-crossed at a right angle spectral sensor), FIG. 15(c) is for the spectral sensor prepared in Example 5 (hereinafter, referred to as Ag-parallel spectral sensor), FIG. 15(d) is for the spectral sensor prepared in Example 6 (hereinafter, referred to as Ag-thin film spectral sensor), and FIG. 15(e) is for the spectral sensor prepared in Example 7 (hereinafter, referred to as Au-thin film spectral sensor), respectively.

Structure of the above-described Example 3 corresponds to the most basic structure of a spectral sensor, comprising a single nanowire formed on top of a SERS inert substrate. According to the structures given in the above-described Examples 3 to 7, contact points with a single nanowire or between nanowires were made by controlling the concentration of a noble metal nanowire which has been dispersed in ethanol. Such method exemplifies the simplest way for mass producing spectral sensors. It is evident that the spectral sensors of the present invention can be produced by individually controlling nanowires using typical apparatuses, considering that noble metal nanowire that is applied to the spectral sensor of the present invention is an individually separated nanowire having a short axis of which diameter is from 50 to 200 nm and a long axis of which length is at least 1 μm. Furthermore, thanks to the said advantages of the noble metal nanowire that is applied to the spectral sensor of the present invention, a specific nanowire among many noble metal nanowires constituting the spectral sensor and a specific part of any specific nanowire can be selected and determined using a simple optical microscope during the measurement based on the spectral sensor of the present invention.

By using the spectral sensor of the present invention, an operation condition of a spectral sensor for improving sensitivity, level of qualitative/quantitative analysis, reproducibility and reliability of data measurement is provided. Further, use of the spectral sensor of the present invention for chemical and biological sensing is provided.

The spectral sensor of the present invention can be used in conjunction with laser beam and Raman spectrometer. Preferably, the said lasers are argon ion laser having a wavelength of 514.5 nm, helium-neon laser having a wavelength of 633 nm, or diode laser having a wavelength of 785 nm. The said Raman spectrometer is preferably a confocal Raman spectrometer. As it is shown in FIG. 16, a set of apparatuses comprising argon-ion laser having a wavelength of 514.5 nm, monochromator, bandpass filter (notch filter), cryostat chamber, CCD detector and an optical microscope is preferred most. The Raman spectra described herein below is a result obtained from the spectral sensor of the present invention using the measurement apparatuses of FIG. 16, with the light intensity of 0.8 mW for 30 sec.

In order to control and optimize Raman enhancement by the spectral sensor of the present invention, it is preferred that polarized laser beam is irradiated to a single noble metal nanowire so that Raman spectrum is observed from a single noble metal nanowire. Because the spectral sensor of the present invention has a well-defined structure and the contact point (i.e., hot spot) also has a controlled structure, in order to achieve a quantitative, reproducible and reliable analysis and an analysis of a sample in ultra low amount, it is preferred that focal position of laser is controlled so that laser beam can be irradiated to a single noble metal nanowire and the focal position of laser beam can be focused to the noble metal nanowire that is being irradiated. In addition, when there are contact points made by nanowires, it is preferred that laser beam is irradiated to the said points and the focal position of laser beam is focused to the said points.

After sprinkling 10⁻²M ethanol solution of Brilliant Cresyl Blue (BCB) to the spectral sensor of single Ag nanowire which has been prepared in Example 3 above, the sensor was dried. Polarization of the laser beam was changed to measure a change in Raman spectrum enhancement of BCB by the difference between the direction of the long axis of Ag nanowire and the polarization direction of laser beam (θ). As it has been described before, focal position of laser is varied so that laser beam can be irradiated to a single noble metal nanowire and the focal position of laser beam can be focused to the noble metal nanowire that is being irradiated. FIG. 17(a) is an optical microscope photo of Ag spectral sensor. FIG. 17(b) shows a change in Raman spectrum of BCB molecule in accordance with a change in laser polarization. Green dot at the center of Ag nanowire in FIG. 17(a) corresponds to irradiated laser beam, and point P is a measuring point to measure point P on substrate of FIG. 17 (b). As it is shown in FIG. 17 (b), Raman spectrum changes according to the angle (θ) between the polarization direction of laser beam and the direction of the long axis of nanowire. Especially when θ is 90°, the most enhanced Raman spectrum was obtained. FIG. 17(c) shows a change in strength of local electric field around Ag nanowire in accordance with a change of laser polarization, wherein said change in strength of local electric field has been calculated using a finite difference time domain (FDTD) method. The result indicates that surface plasmon activity was very strong for certain polarization, especially when laser polarization is perpendicular to the direction of the long axis of the nanowire. FIG. 17(d) shows a change in intensity of Raman enhancement in accordance with a change in laser polarization wherein the data is plotted for different θ values. As it can be understood from FIG. 17(d), Raman spectrum enhancement of single Ag nanowire changes periodically with the direction of laser polarization.

Results shown in FIGS. 17(a) to (d) have a significant importance in that SERS of a single nanowire was directly measured for the first time. Based on such results, it is found that SERS enhancement of a single meal nanowire can be precisely controlled by leaser polarization.

Thus, in order to control and optimize the Raman enhancement of a spectral sensor, it is preferable that polarized laser beam is irradiated to the noble metal nanowire that is applied to the spectral sensor of the present invention to obtain a Raman spectrum. It is also preferred that the angle (θ) between the polarization direction of laser beam and the direction of the long axis of noble metal nanowire is between 30° and 150° or between 210° and 330°. More preferably, it is between 60° and 120° or between 240° and 300°.

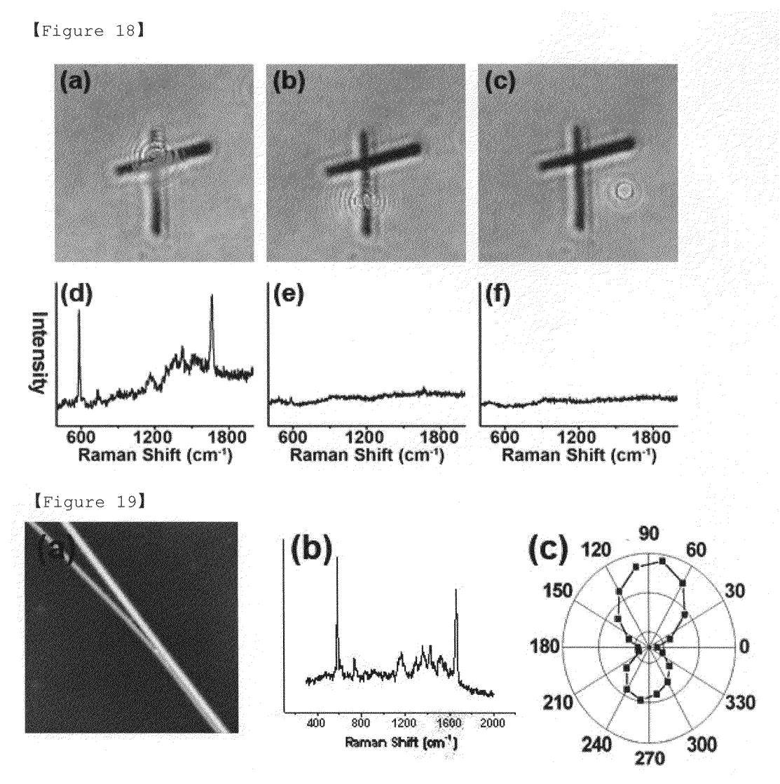

After sprinkling 10⁻⁴M ethanol solution of BCB to the Ag-spectral sensor which has been prepared in Example 4 above (i.e., the nanowire structure having nanowires crossed at a right angle), the sensor was dried and then laser beam was irradiated thereto. Green dots at the center of Ag nanowire in FIGS. 18(a), 18(b) and 18(c) are laser beam irradiated to obtain Raman spectrum at a certain position. FIGS. 18(d), 18(e) and 18(f) are the results of Raman spectrum for BCB molecule taken at various irradiation positions. Specifically, FIG. 18(e) is a result obtained from the measurement wherein laser beam was focused to a certain region of the nanowire instead of the cross point. FIG. 18(f) is a result obtained from the measurement wherein laser beam was focused to a glass plate. FIG. 18(d) is a result obtained from the measurement wherein laser beam was focused to the cross point of two nanowires, showing that a significant amount of SERS enhancement was obtained compared to said two spectra.

After sprinkling10⁻⁴M ethanol solution of BCB to the Ag-parallel spectral sensor which has been prepared in Example 5 above, the sensor was dried and then laser beam was irradiated thereto.

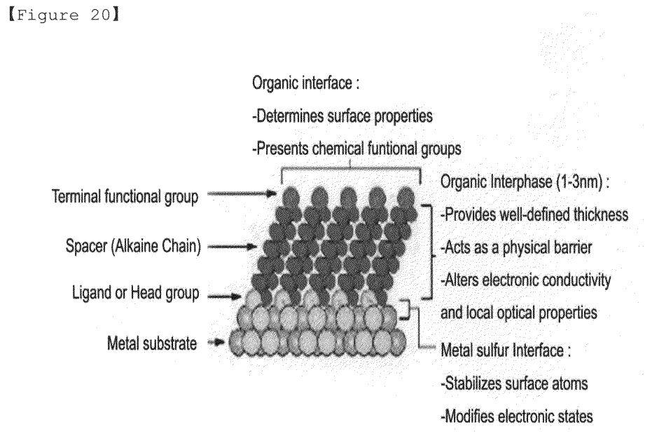

FIG. 19(a) is an AFM image of the spectral sensors in which two Ag nanowires are in contact with each other in a direction of their long axis, and overlapped to each other. As it is shown in the Raman spectrum of BCB molecule in FIG. 19(b), a Raman spectrum having an enhancement which is similar to that of two nanowires that are crossed over each other (FIG. 18(d)) was obtained. This is because at the contact region of two noble metal nanowires the local electrical field is significantly increased. Such enhancement become more evident when the direction of light polarization is changed. FIG. 19(c) shows a decrease and increase in Raman spectrum depending on a change in direction of light polarization. When polarized light which is perpendicular to the longitudinal direction of the overlapped two nanowires is irradiated to the nanowires, signal from Raman scattering was increased the most.

Results shown in FIG. 18 and FIG. 19, which are obtained by taking advantage of a well-defined nanostructure, evidence the presence of hot spot formed by a contact between two nanowires. Although many studies have been actively made for nanoparticles, this is the first time carried out for nanowires. It is quite noteworthy in that the increase and decrease in Raman spectrum caused by contact points was shown directly according to the present invention.

As it is described above, for spectral sensor Structure B in which a contact point is formed by a physical contact between two noble metal nanowires, it is preferred that laser beam is irradiated to said contact point and said point is a focus of laser beam to generate Raman spectrum at said contact point. When polarized laser beam is irradiated, the angle between the polarization direction of laser beam and the direction of the long axes of two nanowires should be optimized depending on a contact structure of the two noble metal nanowire that are in physical contact with each other. When a contact point is formed by two noble metal nanowires that are in contact with each other in direction of the long axis, thesaid direction of the long axis of the two noble metal nanowires is almost parallel to each other.

Thus, it is also preferred that the angle (θ) between the polarization direction of laser beam and the direction of the long axis of two noble metal nanowires is between 30° and 150° or between 210° and 330°. More preferably, it is between 60° and 120° or between 240° and 300°.

When a contact point is formed by crossing over of the long axis of two noble metal nanowires, the angle (θ) between the polarization direction of laser beam and the direction of the long axis of single nanowire that is selected from the two noble metal nanowires is between 30° and 150° or between 210° and 330°. More preferably, it is between 60° and 120° or between 240° and 300°. Therefore, when a contact point is formed by perpendicular crossing over the long axis of two noble metal nanowires, the angle (θ) between the polarization direction of laser beam and the direction of the long axis of single nanowire that is selected from the two noble metal nanowires is between 60° and 120° or between 240° and 300° for each noble metal nanowire, respectively. Thus, on the basis of the long axis of one specific noble metal nanowire selected from the two noble metal nanowires that are crossed at a right angle to each other, said angle is preferably between 330° and 30°, between 60° and 120°, between 150° and 210°, or between 240° and 300°.

As it has been described above regarding the problems associated with prior art, a great difficulty remains for developing a chemical, biological or medical sensor using SERS sensor due to a difficulty for synthesizing noble metal nanowires having high quality, high purity and excellent shape and for establishing a sensor having a well-defined structure and a controlled hot spot. The present invention solved such problems. By placing a chemical or biological substance on top surfaces of a noble metal nanowire, noble metal thin film or noble metal nanowire and noble metal thin film that are applied to the spectral sensor of the present invention, it becomes possible to obtain a reproducible and reliable result for an analyte in ultra low amount. As a result, the sensor of the present invention can be used as a chemical, biological or medical sensor having maximized sensitivity, selectivity and precision for quantitative analysis.

The said biological or chemical substance as an analyte can be present in a state of being adsorbed or chemically bonded to the noble metal nanowire that is applied to the spectral sensor of the present invention. For an actual application, an analyte sample or a solution comprising diluted analyte sample can be sprayed over the spectral sensor. Said analyte sample can be any of chemical or biological substances present in an analyte that is added to the spectral sensor. The said biological substances include body fluid, cell extract and tissue homogenate, etc.

Furthermore, by placing a complex comprising functional groups which can form a spontaneous bonding with a chemical or biological substance on top surfaces of a noble metal nanowire, noble metal thin film or noble metal nanowire and noble metal thin film that are applied to the spectral sensor of the present invention, a sensor which can be used as a chemical, biological or medical sensor can be prepared and used. Among the spectral sensors of the present invention, with respect to the spectral sensor having a noble metal thin film, said analyte or said complex can be present not only on top surface of the nanowire but also on top surface of the noble metal thin film. In addition, said analyte or said complex can be present only on top surface of the noble metal thin film and be measured.

For introducing specific functional groups on surface of nanomaterials, a method based on well known self-assembly phenomena can be preferably used. Thus, it is preferred that the above-described complex is self-assembled and formed a monolayer on the surface of the noble metal nanowire applied to the spectral sensor of the present invention. More preferably, said complex comprises sulfur so that self-assembly based on bonding between said sulfur and the noble metal particles present on the surface of the noble metal nanowire is induced to yield a monolayer. In most cases, such self-assembly occurs spontaneously by a chemical bonding between sulfur and a metal. In particular, since a self-assembly of alkane thiol on surface of gold has been reported, its use is broadened not only to surface of metals including Ag, Pd, Pt and Cu, etc. but also to metal oxides including SiO₂, etc. The favorable aspect of such chemical reaction is that, as it is shown in FIG. 20, a useful functional group can be introduced at the tip of the self-assembled materials. Representative examples of such functional groups include biotin, SpA (staphylococcal protein A) and U1A (antigen), etc. Thus-introduced functional groups can be utilized for a reaction with various types of biomaterials. Because they can react only with a specific kind of biomaterials [e.g., B-SA (biotin and streptavidin), SpA-IgG (staphylococcal protein A and immunoglobulin G), and U1A-10E3 (antigen and antibody)], high selectivity can be obtained. In this case, said functional group is preferably an antibody which can specifically bind to an analyte comprising proteins, or a nucleotide which can complementarily bind to an analyte comprising nucleotides.

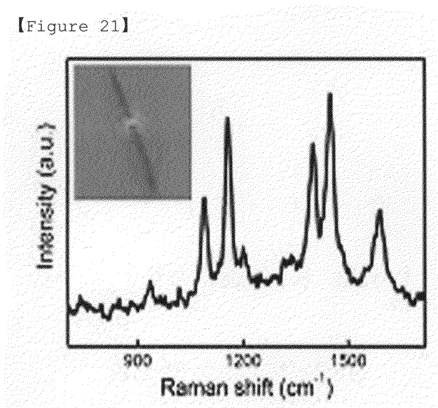

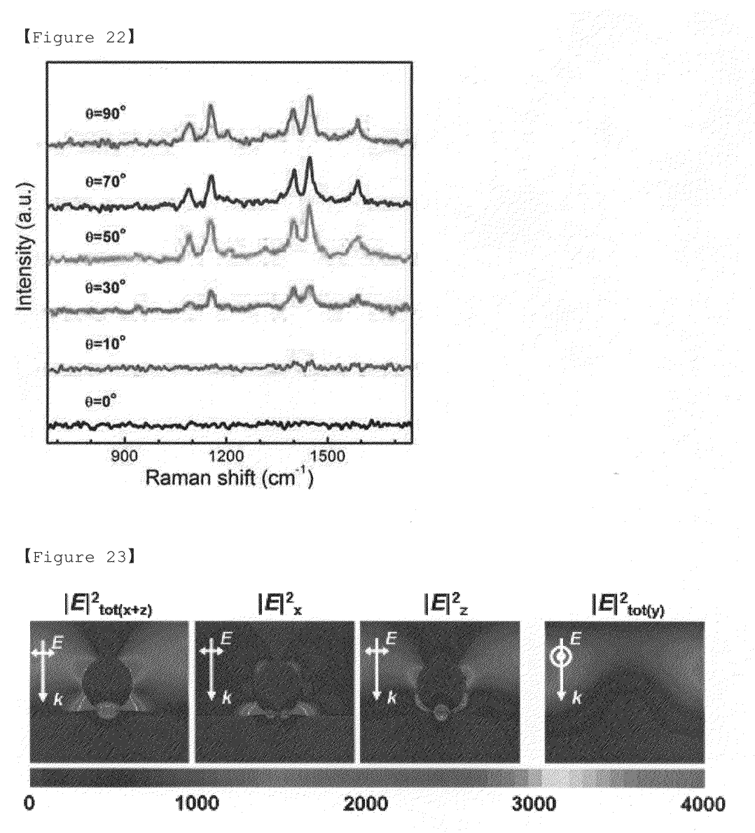

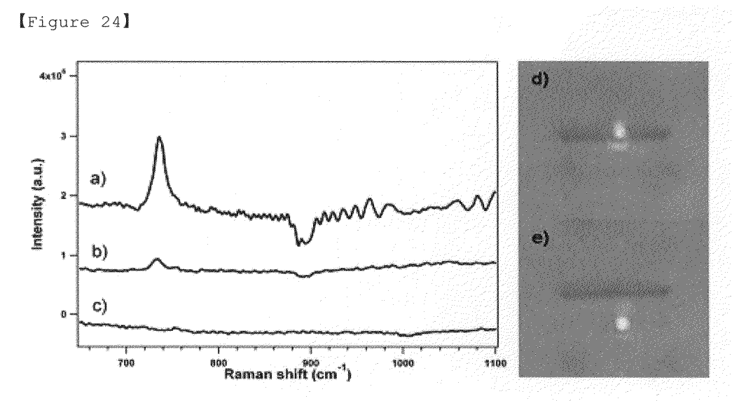

To Ag-thin film spectral sensor that has been prepared in Example 6, self-assembled monolayer (SAM) of para-mercaptoaniline (pMA) was attached and laser beam was irradiated thereto. As it is shown in the result of FIG. 21, very strong Raman spectrum of self-assembled pMA was obtained. FIG. 22 shows a Raman spectrum of pMA obtained from the irradiation with laser beam in accordance with the angle (θ) between the polarization direction of laser beam and the direction of the long axis of nanowire. FIG. 23 shows a distribution of local electric field in accordance with a change in laser polarization, wherein said distribution is calculated using FDTD method. As it is shown in FIG. 22 and FIG. 23, even when a self-assembled layer is formed on a spectral sensor, dependency of the spectral sensor of the present invention on polarization of laser beam is observed. It was also confirmed that a data with consistent intensity can be obtained reproducibly.

To Au-thin film spectral sensor that has been prepared in Example 7, adenine, which is one of the four fundamental bases of DNA, was attached and laser beam was irradiated thereto. Among the four bases, adenine is known for its ability for forming a strong bond with gold. Meanwhile, gold can form a strong bond with thiol so that it can be easily linked to biomolecules, and being free of toxicity it is widely used for the development of biosensors. In addition to silver, gold can show a strong enhancement of SERS. FIG. 24(a) is Raman spectrum of adenine molecule which is measured under the condition that laser focus is present on Au nanowire and polarization of the laser beam is at a right angle with the long axis of the nanowire. FIG. 24(b) is the result obtained under the condition that polarization of the laser beam is parallel to the long axis of the nanowire. FIG. 24(c) is the result obtained under the condition that laser focus is present over gold thin film. FIGS. 24(d) and (e) are an optical photo image taken under the condition that laser focus is present on Au nanowire or gold thin film, respectively. Taken together, it is found that Raman spectrum of adenine molecule can be effectively measured using the spectral sensor of the present invention, and when polarization of laser beam is at a right angle with the long axis of a nanowire Raman spectrum of adenine molecule is significantly enhanced (periodic signal observed at the wavenumber over 900 cm⁻¹ corresponds to a noise originating from CCD detector).

As it has been described in detail above, spectral sensor of the present invention has a well-defined structure and a controlled hot spot. Thus, based on highly sensitive SERS phenomena which can provide information on molecular structure of a sample and has a high selectivity and can be used for a measurement to the level of a single molecule, the spectral sensor of the present invention can be employed for a quantitative or qualitative analysis of chemical or biological samples and for obtaining a reproducible and reliable data. Further, the data obtained from a measurement can be calibrated to determine an absolute concentration, thus providing another advantage.

### INDUSTRIAL APPLICABILITY

Spectral sensor for SERS (surface-enhanced Raman scattering) of the present invention is advantageous in that it has a geometric structure consisting of a single noble metal single-crystal nanowire and several single nanolines, and it can be used for obtaining surface-enhanced Raman scattering having high sensitivity, high selectivity, and strong Raman intensity based on experiments made on surface-enhanced Raman scattering, depending on the polarization direction of laser beam. Further, by using a noble metal single-crystal nanowire which has a high quality, a high purity and an excellent shape, position of individual nanowires and the geometric structure made by several nanowires can be controlled, and intensity of surface-enhanced Raman scattering can be improved by adjusting hot spot between noble metal film layer and noble metal nanowire and polarization direction of laser beam. In addition, the spectral sensor for SERS of the present invention can be used as a sensor for detecting chemicals by using surface of the noble metal nanowire, and by introducing specific functional groups on the surface of the noble metal nanowire to detect biological substances, a nano-bio hybrid structure can be formed and used for obtaining highly sensitive Raman spectrum of the biological substances. Consequently, it can be advantageously used as a biological sensor or a medical sensor for early diagnosis of disease.

1. Spectral sensor which is for determining the presence or the amount of chemical or biological materials comprised in an analyte, used in conjunction with laser beam and Raman spectroscopic detector, and comprises (i) a substrate, (ii) a noble metal thin film located on top of the said substrate and (iii) single-crystal noble metal nanowires located on top of said noble metal thin film, wherein a contact point is formed between the said noble metal thin film and the said noble metal nanowires and an SERS (Surface-Enhanced Raman Scattering) enhancement is achieved by largely increased local electric field that is induced on thensaid contact point.

2. The spectral sensor of claim 1, wherein the said noble metal nanowires have a short axis of which diameter is within the range of between 20 and 200 nm and a long axis of which length is at least 1 μm.

3. The spectral sensor of claim 2, wherein the structure of the said noble metal nanowire on the said noble metal thin film is a cluster in which at least one noble metal nanowire is individually controlled and determined.

4. The spectral sensor of claim 3, wherein the single nanowire is considered as one unit, and at least one the said unit is arranged on the said substrate.

5. The spectral sensor of claim 1, wherein the number of the said contact point is controlled by the surface roughness of the noble metal thin film.

6. The spectral sensor of claim 5, wherein the said surface roughness is adjusted by a physical, chemical or thermal method.

7. The spectral sensor of claim 1, wherein polarized laser beam is irradiated to a single noble metal nanowire and the said laser beam is focused to the said irradiated noble metal nanowire, so that the said SERS (Surface-Enhanced Raman Scattering) is generated from a single noble metal nanowire.

8. The spectral sensor of claim 7, wherein the said SERS (Surface-Enhanced Raman Scattering) is generated on the condition that the angle (θ) between the polarization direction of the said polarized laser beam and the direction of the long axis of the said noble metal nanowire is between 30° and 150° or between 210° and 330°.

9. The spectral sensor of claim 1, wherein said noble metal nanowire is Ag single-crystal nanowire.

10. The spectral sensor of claim 9, wherein for the said Ag single-crystal nanowire, the diameter of its short axis is in the range of between 80 and 150 nm and the length of its long axis is at least 10 μm, and the end of its long axis has a smooth curvy shape.

11. The spectral sensor of claim 1, wherein said noble metal nanowire is Au single-crystal nanowire.

12. The spectral sensor of claim 11, wherein for the said Au single-crystal nanowire, the diameter of its short axis is in the range of between 50 and 150 nm and the length of its long axis is at least 5 μm.

13. The spectral sensor of claim 9, wherein the said noble metal thin film is Ag thin film.

14. The spectral sensor of claim 11, wherein the said noble metal thin film is Au thin film.

15. Spectral sensor which is for determining the presence or the amount of chemical or biological materials comprised in an analyte applied to the sensor, used in conjunction with laser beam and Raman spectroscopic detector, and comprises (i) a substrate and (ii) single-crystal noble metal nanowires located on top of the said substrate, wherein a contact point is formed by a physical contact of the said two noble metal nanowires and an enhancement of SERS (Surface-Enhanced Raman Scattering) is achieved by local electric field that is formed on the said contact point.

16. The spectral sensor of claim 15, wherein the laser beam is irradiated to the said contact point, so that the said SERS (Surface-Enhanced Raman Scattering) is generated.

17. The spectral sensor of claim 16, wherein the said contact point is the focus of the laser beam.

18. The spectral sensor of claim 15, wherein the said contact point is formed by crossing over of the long axis of two noble metal nanowires.

19. The spectral sensor of claim 18, wherein the said crossing is the crossing at a right angle.

20. The spectral sensor of claim 16, wherein the said contact point is formed by two noble metal nanowires in contact with each other along their long axes.

21. The spectral sensor of claim 16, wherein the laser beam irradiated to the said contact point is polarized.

22. The spectral sensor of claim 15, wherein the said physically contacted two noble metal nanowires are considered as one unit and at least one the said unit is arranged on the said substrate.

23. The spectral sensor of claim 15, wherein the said noble metal nanowire is Ag single-crystal nanowire.

24. The spectral sensor of claim 23, wherein for the said Ag single-crystal nanowire, the diameter of its short axis is in the range of between 80 and 150 nm and the length of its long axis is at least 10 μm.

25. The spectral sensor of claim 15, wherein the said noble metal nanowire is Au single-crystal nanowire.

26. The spectral sensor of claim 25, wherein for said Au single-crystal nanowire, the diameter of its short axis is in the range of between 50 and 150 nm and the length of its long axis is at least 5 μm.

27. The spectral sensor of claim 1, wherein chemical or biological substances are placed on the surface of the said noble metal nanowire.

28. (canceled)

29. The spectral sensor of claim 1, wherein a complex comprising functional groups which can form a spontaneous chemical bonding with a chemical or biological samples are placed on the surface of the said noble metal nanowire.

30. The spectral sensor of claim 29, wherein the said complex is self-assembled on the surface of said noble metal nanowire.

31. (canceled)

32. The spectral sensor of claim 29, wherein the said functional group is an antibody which can specifically bind to an analyte comprising protein or a nucleotide which can complementarily bind to an analyte comprising nucleotides.

33. (canceled)

34. The spectral sensor of 15, wherein chemical or biological substances are placed on the surface of the said noble metal nanowire.

35. The spectral sensor of claim 15, wherein a complex comprising functional groups which can form a spontaneous chemical bonding with a chemical or biological samples are placed on the surface of the said noble metal nanowire.

36. The spectral sensor of claim 35, wherein the said complex is self-assembled on the surface of said noble metal nanowire.

37. The spectral sensor of claim 35, wherein the said functional group is an antibody which can specifically bind to an analyte comprising protein or a nucleotide which can complementarily bind to an analyte comprising nucleotides.
